(19) United States
(12) Patent Application Publication
(10) Pub. No.: US 2007/0171389 A1
(43) Pub. Date: Jul. 26, 2007

(54) Method and apparatus for detecting filter status

(75) Inventor: Hsin-Hung Li, Lujhu Township (TW)

Correspondence Address: RABIN & Berdo, PC, 1101 14TH STREET, NW, SUITE 500, WASHINGTON, DC, 20005, US

(73) Assignee: BenQ Corporation, Taoyuan Shien (TW)

(21) Appl. No.: 11/651,585

(22) Filed: Jan. 10, 2007

(30) Foreign Application Priority Data
Jan. 25, 2006 (TW) 95102921

(51) Int. Cl. G03B 21/00

(52) U.S. Cl. 353/122

(57) ABSTRACT

A method and an apparatus for detecting a filter status. The apparatus is applied to an electronic apparatus, such as a projector, having a ventilation opening and a dust filter, and includes a filter status testing film and a photosensor. The filter status testing film is embedded in the dust filter. The photosensor determines a status of the dust filter by sensing a color variation of the filter status testing film. The method includes sensing the color variation of the dust filter and determining the status of the dust filter according to the color variation.

This application claims the benefit of Taiwan application Serial No. 95102921, filed Jan. 25, 2006, the subject matter of which is incorporated herein by reference.

### BACKGROUND OF THE INVENTION

1. Field of the Invention

The invention relates in general to a detecting apparatus, and more particularly to an apparatus and a method of detecting a filter status.

2. Description of the Related Art

In a conventional projector, a light bulb serving as a lighting source tends to generate heat to rise the temperature, and the bulb may be exploded. The typical projectors utilize cooling systems to lower the temperature of the light bulb. The cooling system typically utilizes air passages to drain the hot air out of the projector smoothly and introduce the cooling air from the outside. A dust filter is disposed at a ventilation opening of the projector to filter out the dust of the external air.

In order to prevent the filter from becoming smudgy and being blocked to decrease the introduced gas quantity after a long term of use, the conventional method is to determine whether the filter has to be replaced according to a timer. That is, the projector outputs a warning signal to tell the user to replace the filter after a specific period of time, such as 2000 hours, has elapsed.

However, the used status of the filter varies with the variation of the environment. If the user uses the projector in an environment with the relatively low level of dust, the projector warns the user to replace the filter after 2000 hours. However, the filter is still very clean and does not have to be replaced. Alternatively, when the user uses the projector in the environment with the relatively high level of dust, the filter may be blocked and thus out of work, but the time of warning is still not reached. Thus, the user still uses the projector, in which the filter is blocked and the cooling flow is insufficient, and the lighting source tends to be overheated and thus to explode dangerously.

### SUMMARY OF THE INVENTION

The invention is directed to a method and an apparatus for detecting a status of a dust filter correctly.

According to a first aspect of the present invention, a filter status detecting apparatus to be applied to an electronic apparatus having a ventilation opening and a dust filter is provided. The detecting apparatus includes a filter status testing device and a photosensor. The filter status testing device is embedded in the dust filter. The photosensor determines a status of the dust filter by sensing a color variation of the filter status testing device.

According to a second aspect of the present invention, a projector is provided. The projector includes a light source, a light processor, a projection lens set, a ventilation opening, a dust filter, a filter status testing device and a photosensor. The light source generates a light beam. The light processor generates an image according to the light beam. The projection lens set images the image onto a screen. The dust filter is disposed in the ventilation opening, and the filter status testing device is embedded in the dust filter. When the projector is being operated, the photosensor determines a status of the dust filter by sensing a color variation of the filter status testing device.

According to a third aspect of the present invention, a filter status detecting method is provided. The method includes sensing a color variation of a dust filter and determining a status of the dust filter according to the color variation.

The invention will become apparent from the following detailed description of the preferred but non-limiting embodiments. The following description is made with reference to the accompanying drawings.

### BRIEF DESCRIPTION OF THE DRAWINGS

FIG. 1 is a functional block diagram showing a projector according to a preferred embodiment of the invention.

FIG. 2 is a schematic illustration showing a dust filter 220.

FIG. 3 is a schematic illustration showing a photosensor according to a preferred embodiment of the invention.

FIG. 4 is a flow chart showing a filter status detecting method according to a preferred embodiment of the invention.

### DETAILED DESCRIPTION OF THE INVENTION

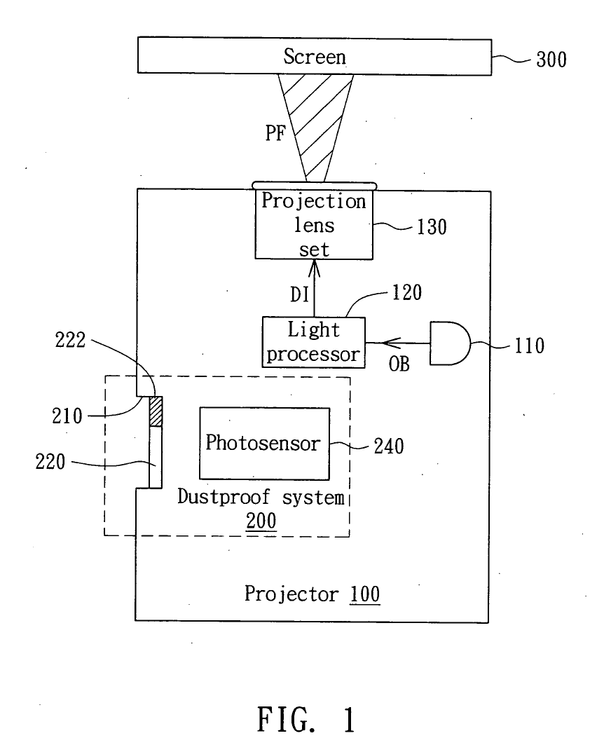

FIG. 1 is a functional block diagram showing a projector 100 according to a preferred embodiment of the invention. Referring to FIG. 1, the projector 100 for displaying a frame PF on a screen 300 includes a light source 110, a light processor 120, a projection lens set 130 and a dustproof system 200. The light source 110 generates a light beam OB and transmits the light beam OB to the light processor 120. The light processor 120 generates an image DI according to the light beam OB and images the image DI onto the screen 300 through the projection lens set 130 to achieve the effect of projection. The dustproof system 200 includes a ventilation opening 210, a dust filter 220 and a filter status detection device. The detection device includes a filter status testing device 222 and a photosensor 240.

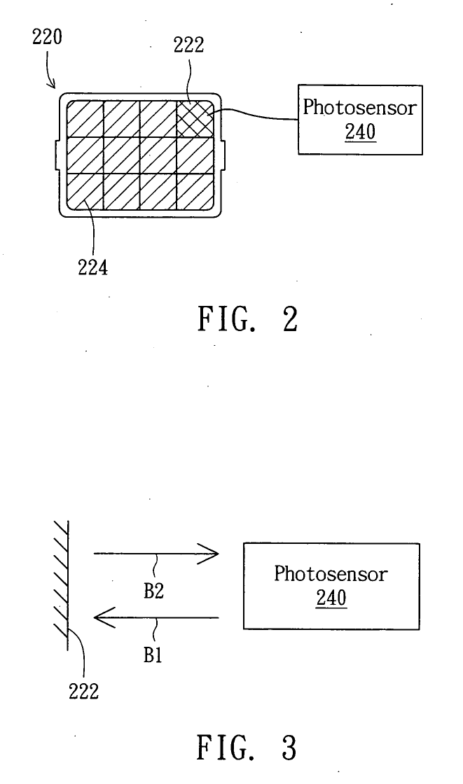

FIG. 2 is a schematic illustration showing a dust filter 220. As shown in FIG. 2, the dust filter 220 is composed of multiple filters 224 made of, for example, a foaming material, and the filter status testing device 222 is embedded therein. The filter status testing device 222 maybe a film which is made of non-woven cloth, for example.

One dust filter 220 may become smudgy (e.g., change from white to black) due to the dust deposition after a period of time. The filter 224 is made of the foaming material with the nonuniform density, so the filter blocking status detected according to the filter 224 may cause a relatively great error. So, the embodiment additionally embeds the testing device 222 into the dust filter 220. The testing device 222, for example, is made of the non-woven cloth with the uniform density, so the filter blocking status may be detected correctly according to the testing device 222. Thus, the photosensor 240 can effectively determine the status of the dust filter 220 by detecting a color variation of the filter status testing device 222 so as to remind the user to replace the filter.

FIG. 3 is a schematic illustration showing the photosensor 240 according to a preferred embodiment of the invention. The photosensor 240 outputs a light beam B1 to the filter status testing device 222. When the light beam B1 is transmitted to the filter status testing device 222, the surface of the filter status testing device 222 reflects the light beam B1. The photosensor 240 receives a reflected light beam B2 and calculates the color variation according to RGB components of the reflected light beam. In order to judge the color variation, the photosensor 240 has a default color value. When the photosensor 240 receives the reflected light beam B2, the photosensor 240 compares the sensed color variation with the default color value to determine the status of the dust filter. When the color variation is greater than the default color value, it represents that the filter has become smudgy, so an associated warning signal is outputted to inform the user to replace the filter. In order to detect the color variation more precisely, this embodiment measures the color variation of the filter status testing device by analyzing the RGB components of the reflected light beam B2. In addition, this embodiment may also judge the color variation by only measuring the gray-scale value of the reflected light beam B2.

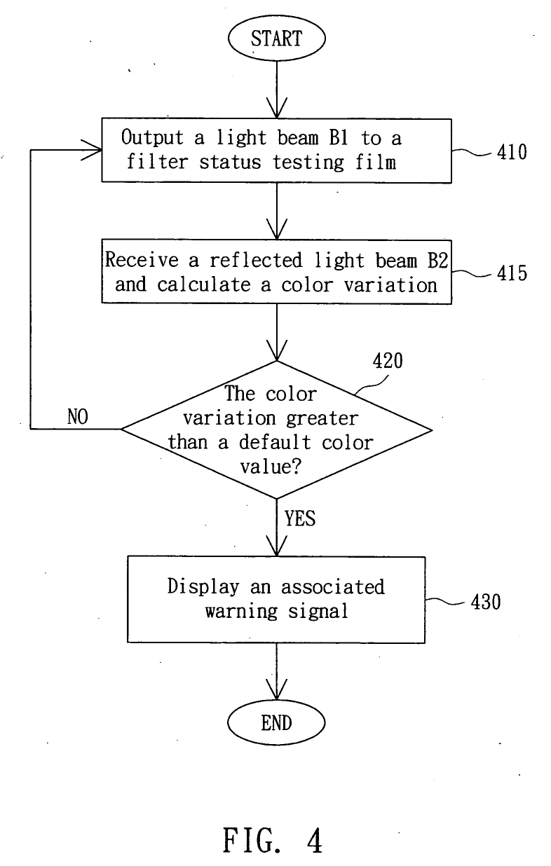

FIG. 4 is a flow chart showing a filter status detecting method according to a preferred embodiment of the invention. The filter status detecting method of this embodiment is applied to the projector 100. First, step 410 is performed to output the light beam B1 to the filter status testing device 222 using the photosensor 240. Next, step 415 is performed to receive the reflected RGB light beam B2 reflected by the filter status testing device 222 and to calculate the color variation of the dust filter. Then, step 420 is performed to determine whether the color variation is greater than the default color value. If the color variation is greater than the default color value, step 430 is performed to display the associated warning signal. Thus, the user can know that the dust filter has to be replaced according to the associated warning signal. If the color variation is not greater than the default color value, the procedure goes back to step 410 to continue measuring the color variation.

In order to ensure the safety in usage, this embodiment further provides a safety mechanism. The method of this embodiment can determine whether the color variation is greater than a threshold value, which is greater than the above-mentioned default value, using the photosensor 240. If the measured color variation is greater than the threshold value, it represents that the dust filter has become smudgy, has been blocked and cannot be used any more, and the operation of the projector 100 is forced to stop until the user has replaced the dust filter 220. Thus, it is possible to prevent the danger of bulb explosion due to the disregard of the associated warning signal.

In addition, in order to reduce the risk of damaging the projector 100 when the temperature inside the projector 100 is increased due to the blocked ventilation opening 210, the method of this embodiment may further measure the temperature inside the projector 100 to serve as a safety indicator. That is, the measured temperature is compared with a first predetermined temperature, and the associated warning signal is displayed to inform the user that the temperature inside the projector 100 is too high if the measured temperature is higher than the first predetermined temperature. Similarly, in order to prevent the user from disregarding the associated warning signal, the method of this embodiment may further compare the measured temperature with a second predetermined temperature, which is higher than the first predetermined temperature. If the measured temperature is higher than the second predetermined temperature, the projector 100 is forced to stop until the projector is cooled down. In practice, the photosensor 240 of the invention may be designed to have the function of sensing the temperature inside the projector 1000so as to achieve the object of warning the user.

In view of this, the embodiment of the invention provides the method and apparatus for detecting the filter status to detect the used status of the dust filter of the projector as the reference for replacing the dust filter. Thus, it is possible to prevent the bulb explosion due to the blocked filter in a highly precise and effective manner.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A filter status detecting apparatus being applied to an electronic apparatus having a ventilation opening and a dust filter disposed in the ventilation opening, the detecting apparatus comprising:
a filter status testing device embedded in the dust filter; and
a photosensor for determining a status of the dust filter by sensing a color variation of the filter status testing device.

2. The apparatus according to claim 1, wherein the photosensor emits a light beam to the filter status-testing device, which reflects the light beam to form a reflected light beam, and the photosensor receives the reflected light beam and calculates the color variation according to RGB components of the reflected light beam.

3. The apparatus according to claim 1, wherein the photosensor has a default color value, and the photosensor determines whether the dust filter has to be replaced according to a comparison result obtained by comparing the color variation with the default color value.

4. The apparatus according to claim 3, wherein the photosensor determines whether the color variation is greater than the default color value, and outputs an associated warning signal to inform a user to replace the dust filter if the color variation is greater than the default color value.

5. The apparatus according to claim 1, wherein, the filter status testing device is a film made of non-woven cloth.

6. A projector, comprising:
a light source for generating a light beam;
a light processor for generating an image according to the light beam;
a projection lens set for imaging the image onto a screen;
a ventilation opening;
a dust filter disposed in the ventilation opening;
a filter status testing device embedded in the dust filter; and
a photosensor for determining a status of the dust filter by sensing a color variation of the filter status testing device.

7. The projector according to claim 6, wherein the photosensor emits the light beam to the filter status testing device, which reflects the light beam to form a reflected light beam, and the photosensor receives the reflected light beam and calculates the color variation according to RGB components of the reflected light beam.

8. The projector according to claim 6, wherein the photosensor has a default color value, and the photosensor determines whether the dust filter has to be replaced according to a comparison result obtained by comparing the color variation with the default color value.

9. The projector according to claim 8, wherein the photosensor determines whether the color variation is greater than the default color value, and displays an associated warning signal to inform a user to replace the dust filter if the color variation is greater than the default color value.

10. The projector according to claim 6, wherein, the filter status testing device is a film made of non-woven cloth.

11. A filter status detecting method being applied to an electronic apparatus, which comprises a ventilation opening and a dust filter disposed in the ventilation opening, the method comprising the steps of:
sensing a color variation of the dust filter; and
determining a status of the dust filter according to the color variation.

12. The method according to claim 11, further comprising the steps of:
determining whether the color variation is greater than a default color value; and
displaying an associated warning signal if the color variation is greater than the default color value, or otherwise returning to the step of sensing the color variation of the dust filter.

13. The method according to claim 12, further comprising the steps of:
determining whether the color variation is greater than a threshold value, which is greater than the default color value; and
forcing the electronic apparatus to stop operating if the color variation is greater than the threshold value, or otherwise returning to the step of sensing the color variation of the dust filter.

14. The method according to claim 11, wherein the electronic apparatus further comprises a filter status testing device embedded in the dust filter, and the step of determining the status of the dust filter comprises:
emitting a light beam to the filter status testing device; and
receiving a reflected light beam, which is formed after the filter status testing device reflects the light beam, and calculating the color variation according to RGB components of the reflected light beam.
